(19) United States
(12) Patent Application Publication
(10) Pub. No.: US 2020/0247096 A1
(43) Pub. Date: Aug. 6, 2020

(54) Improvements Relating to Insulation

(71) Applicant: Hunt Technology Limited, Hertfordshire (GB)

(72) Inventors: Timothy John Woodbridge, London (GB); Leslie James Squires, Blairgowrie (GB); James Smith, Lancashire (GB)

(21) Appl. No.: 16/482,460

(22) PCT Filed: Jan. 31, 2018
(86) PCT No.: PCT/GB2018/050286

§ 371 Date: Jul. 31, 2019

(30) Foreign Application Priority Data
Jan. 31, 2017 (GB) 1701603.1
Mar. 13, 2017 (GB) 1703989.2
Aug. 30, 2017 (GB) 1713917.1
Nov. 3, 2017 (GB) 1718276.7

(51) Int. Cl. B32B 27/12; B32B 27/08

(52) U.S. Cl. CPC B32B 27/12; B32B 7/12; B32B 27/08

(57) ABSTRACT

A flexible, vapour permeable cargo cover laminate comprising: an outer layer comprising a substrate bearing a coating, the coating having particles of infra-red reflective matter dispersed within a polymeric matrix and providing an exposed low-emissivity surface on an outward face of the outer layer; and a support layer laminated to an inward face of the outer layer. Other cargo laminates, cargo covers and methods of insulating cargo are also disclosed.

### TECHNICAL FIELD

This invention relates to cargo covers. In particular, though not exclusively, this invention relates to flexible cargo cover laminates, to cargo covers, to methods of making cargo covers, and to methods of insulating cargo.

### BACKGROUND

Many products are transported long distances as cargo and are required to be kept within defined temperature ranges during transport. Pharmaceutical products and perishable food products are examples of such products, as are certain electronic items. Products may be shipped by any known means, road, ship or air transport, and are usually packed on pallets for ease of handling during shipping. The palletised goods may be potentially subjected to wide temperature fluctuations during transport. For example, they may be held at relatively low temperatures in the cargo hold of an aircraft and then left outside prior to the next stage of their journey and be subjected to high incident radiation and high ambient temperatures.

Products which are particularly sensitive to temperature changes during transport may advantageously be palletised and then protected with a thermal insulation cover (cargo cover). A cargo cover may, for example, cover part of a pallet, typically the four sides and top of the pallet or, by providing a protective sheet under the pallet may cover all six sides of the pallet.

Current thermally-insulating cargo covers include a range of materials which may be for example a simple, thin protective cover e.g. a single-layer sheet, which may carry a reflective surface, which provides a means of modestly attenuating the effects of external temperature fluctuations for example by reducing the direct influence of incident solar radiation.

Alternative commercially available cargo covers are made from multi-layer materials designed to provide more significant thermal insulation properties i.e. their thermal insulation values for example as measured by thermal resistance (R-value in m²·K/W), contribute to their performance in protecting pallet contents from excessive thermal fluctuations.

Examples of such covers include those made from either single or multiple layers of bubble-wrap type materials, often laminated to reflective (low emissivity) outer layers. The thermal insulation performance of such laminated materials is not particularly good i.e. the R-values are relatively low, since heat transfer by convection can occur within the air bubbles which are macro-bubbles, the bubble dimensions being measured in multiple millimetres. The reflective outer surface of products which incorporate reflective outer layers also give problems of glare when handled in bright sunlight. A further disadvantage of these covers is that when the covers themselves are being shipped to the customer for use, they are not very compressible and therefore are voluminous and relatively expensive to ship.

Many prior art cargo covers are moisture vapour impermeable, which can lead to undesirable condensation within the cover. There is hence a need for vapour permeable cargo covers.

An example of a known moisture vapour permeable (breathable) cargo cover design is the Tyvek® XTREME™ W50 Cargo Cover (Du Pont). This cover comprises a layer of flash-spun polyethylene reflectively coated on one side with aluminium, giving a low emissivity surface, and adhesively bonded, on the aluminised side, to a wadding i.e. a fibrous, bulky thermal insulation layer. A smooth, fibrous, air-open nonwoven fabric is further bonded to the bulky insulation layer and forms the inner surface of the cover.

The low-emissivity surface of the Tyvek® XTREME™ W50 Cargo Cover faces inwards, which reduces its effectiveness against incident solar radiation. However, the aluminised nature of the low emissivity surface would lead to increased oxidation and corrosion if it was exposed outwards, particularly on exposure to acid rain or corrosive ambient conditions such as salt-laden air in coastal and marine environments.

A further problem with prior art cargo covers is that they fail to mitigate uneven temperature increases within cargo. For example it has been found that cargo covers lead to more rapid temperature increases in an upper region of a pallet compared to a lower region.

There remains a need in the art for alternative and improved cargo covers. It is an object of the invention to address at least one problem associated with the prior art.

### SUMMARY OF THE INVENTION

Some aspects of the invention relate to a vapour permeable cargo cover laminate with an exposed low-emissivity surface provided by a coating containing dispersed infra-red reflective particles.

From one aspect of the invention there is provided a flexible, vapour permeable cargo cover laminate comprising: an outer layer comprising a substrate bearing a coating, the coating having particles of infra-red reflective matter dispersed within a polymeric matrix and providing an exposed low-emissivity surface on an outward face of the outer layer; and a support layer laminated to an inward face of the outer layer.

The flexible, vapour permeable cargo cover laminate has a low-emissivity surface on an outward face, attenuating the effects of external temperature fluctuations, for example by reducing the direct influence of incident solar radiation. Whilst the low-emissivity surface is exposed, it is not vulnerable to oxidation and corrosion in the manner of an aluminised coating. Nevertheless, the laminate is vapour permeable and can therefore help avoid condensation.

The outer layer of the laminate may advantageously have a moisture vapour transmission rate (MVTR) of at least 50 g/m².day, preferably at least 100 g/m².day, more preferably at least 200 g/m².day, even more preferably at least 500 g/m².day. Optionally, the outer layer of the laminate may have a moisture vapour permeability greater than 820 g/m².day. Moisture vapour permeability or moisture vapour transmission rate (MVTR) are provided throughout this specification based on testing with a Lyssy Model L80-5000 Water Vapor Permeability Tester at 100%/15% RH, i.e. 85% RH difference and 23° C.

The low-emissivity surface may suitably have an emissivity of less than 0.5, preferably less than 0.3, more preferably less than 0.25 and most preferably less than 0.20. Emissivity expresses the amount of energy radiated by a material, matter or surface. An ideal material or surface emitting the highest theoretical level of radiant energy would have an emissivity, ϵ, of 1 and an ideal material or surface emitting no radiant energy would have an emissivity of 0. In practice all objects have an emissivity between 0 and 1. All emissivity values (ϵ) herein are given at a temperature of 25° C.

Advantageously, to guard against rain and other environmental conditions it is envisaged that the outer layer be substantially air and liquid water impermeable. Suitably, the outer layer may have a hydrostatic head of at least 100 cm, preferably at least 500 cm.

The substrate of the outer layer may comprise any suitably liquid water impermeable, water vapour permeable and dimensionally stable layer capable of bearing the coating.

Advantageously, the substrate may comprise a membranous layer or a film. The substrate may in principle be fibrous or filamentous. However, advantageously, the substrate may comprise a monolithic (non-porous) or microporous film or membrane. The substrate may thus be non-fibrous.

The thickness of the substrate may vary as desired but may typically be in the range of from 5 to 400 μm, in particular in the range of from 20 to 200 μm.

The substrate may be a single-layer substrate or a multi-layer substrate. Multi-layer substrates may be formed, for example by coextrusion and/or lamination.

Conveniently, the substrate may be polymeric. Suitably, the substrate may comprise a synthetic organic polymer, in particular a polyolefin.

In an embodiment, the substrate comprises organic biopolymers such as one or more of suitable carbohydrates (starch, cellulose, glycogen, hemi-cellulose, chitin, fructans, inulin, lignin and/or pectin based materials), gums, proteins (animal or vegetable), colloids and hydrocolloids, polylactic, polygalactic and/or cellulose.

Provided the substrate retains the desired level of liquid water impermeability, the substrate may comprise micropores or microperforations to help provide moisture vapour permeability.

In an embodiment the substrate comprises a microporous membrane. A microporous membrane is a three-dimensional matrix or lattice type structure that includes matrix of interconnecting pores extending through the microporous membrane.

As used herein, the term “microporous membrane” may include membranes having a mean pore size in the range of from about 0.05 μm to about 0.3 μm.

Suitably, the microporous membrane may have a thickness in the range of from 5 to 400 μm, in particular in the range of from 20 to 200 μm.

The substrate may comprise a polymeric, in particular polyolefinic, microporous membrane, in particular a microporous membrane comprising, substantially or wholly, polypropylene. The use of such materials is conveniently enabled by the coating, which provides protection for the substrate against incident solar radiation which might otherwise make it prone to rapid degradation.

Using a cellulose based substrate layer can significantly increase resistance to UV light exposure as compared to currently available products based on UV-stabilised polyolefin, in particular polypropylene. However, this has been found not to be necessary due to the protective effect of the coating.

The coating may be of any suitable thickness consistent with achieving a desired level of emissivity and/or moisture vapour permeability in the laminate. For optimal balance between low emissivity and moisture vapour permeability, the coating weight may preferably lie in the range from 0.8 g/m² to 2.5 g/m². In an embodiment, the thickness of the coating may be up to about 1.5 μm, in particular up to about 0.75 μm, such as up to about 0.5 μm. For example, the thickness may be in the range of from 0.1 μm to 0.75 μm.

The coating may be formed in any suitable manner, e.g. from a solvent or water based dispersion or solution, from a solvent-less system, or as an extrusion coating. The coating layer may be applied directly on the substrate, or there may be provided one or more intervening layers. The substrate may be primed or otherwise treated to aid adherence of the coating layer thereon.

The polymeric matrix of the coating may advantageously be substantially continuous and allow transfer of moisture vapour by molecular diffusion. Conveniently, the polymeric matrix and coating as a whole may be substantially liquid water impermeable.

The polymeric matrix of the coating layer may be composed of synthetic organic polymers (e.g. polyacrylic ester, polyvinyl acetate copolymers, polyurethanes, aliphatic polyamides such as nylon 6, nylon 6.6, nylon 4.6, polysulfone and polyethersulfone and the like), cellulose derivatives (e.g. ethers, esters, nitrocellulose, etc.), or modified or unmodified naturally occurring polymers (e.g. starches, proteins, etc.). Mixtures of these with or without the addition of inorganic additives (e.g. fumed silica) can also be used. However, it is generally preferred that such inorganic additives be substantially absent from the coating layer since such additives tend to increase the emissivity of the film.

Suitably, the polymeric matrix of the coating may comprise polymer chains having relatively high and relatively lower crystallinity sections to facilitate transfer of moisture vapour by molecular diffusion.

In an embodiment, the polymeric matrix of the coating comprises a block copolymer. The block copolymer may optionally be selected from styrene butadiene resins and hydrophilic polyurethanes including polyester urethanes, polyether urethanes, polycarbonate urethanes and polyurethane urea polymers, or combinations thereof.

Particularly preferred examples include styrene butadiene styrene resins and hydrophilic polyurethanes. Hydrophilic polyurethanes which may be used according to the invention as preferred material for the binder are the reaction product of (a) polyisocyanates; and (b) polyols containing at least two isocyanate reactive groups; and (c) optionally an active hydrogen-containing chain extender.

Suitable polyisocyanates comprise aliphatic, cycloaliphatic, or aromatic polyisocyanates. As examples of suitable aliphatic diisocyanates, there may be mentioned 1,4-diisocyanatobutane, 1,6-diisocyanatohexane, 1,6-diisocyanato-2,2,4-trimethylhexane and 1,1,2-diisocyanatododecane, either alone or in admixture. Particularly suitable cycloaliphatic diisocyanates include 1,3- and 1,4-diisocyanatocyclohexane, 2,4-diisocyanato-1-methylcyclohexane, 1,3-diisocyanato-2-methylcyclohexane, 1-isocyanato-2-(isocyanatomethyl)cyclopentane, 1,1′-methylenebis[4-isocyanato-cyclohexane, 1,1-(1-methylethylidene)bis(4- isocyanatocyclohexane), 5-isocyanato-1-isocyanatomethyl-1,3,3-trimethylcyclohexane(isophoronediisocyanate), 1,3- and 1,4-bis(isocyanatomethyl)cyclohexane, 1,1-methylenebis[4-isocyanato- 3-methylcyclohexane, 1-isocyanato-4(or3)-isocvanatomethyl-1-methylcyclohexane], either alone or in admixture.

Particularly suitable aromatic diisocyanates include 1,4-diisocyanatobenzene, 1,1′-methylenebis[4-isocyanatobenzene], 2,4-diisocyanato-1-methylbenzene, 1,3-diisocyanato-2-methyl benzene, 1,5-diisocyanatonaphthalene, 1,1-(1-methylethylidene)bis[4-isocyanatobenzene, 1,3- and 1,4-bis(1-isocyanato-1-methylethyl)benzene, either alone or in admixture. Aromatic polyisocyanates containing 3 or more isocyanate groups may also be used such as 1,1′,1″-methylidynetris[4-isocyanatobenzene] and polyphenyl polymethylene polyisocyanates obtained by phosgenation of aniline/formaldehyde condensates.

The polyols containing at least two isocyanate reactive groups may be polyester polyols, polyether polyols, polycarbonate polyols, polyacetal polyols, polyesteramide polyols or polythioether polyols. The polyester polyols, polyether polyols and polycarbonate polyols are preferred.

Suitable polyester polyols which may be used include the hydroxyl-terminated reaction products of polyhydric, preferably dihydric alcohols (to which trihydric alcohols may be added) with polycarboxylic, preferably dicarboxylic acids or their corresponding carboxylic acid anhydrides. Polyester polyols obtained by the ring opening polymerization of lactones such as ϵ-caprolactone may also be included.

The polycarboxylic acids which may be used for the formation of these polyester polyols may be aliphatic, cycloaliphatic, aromatic and/or heterocyclic and they may be substituted (e.g. by halogen atoms) and saturated or unsaturated. As examples of aliphatic dicarboxylic acids, there may be mentioned, succinic acid, glutaric acid, adipic acid, suberic acid, azelaic acid, sebacic acid and dodecanedicarboxylic acid. As an example of a cycloaliphatic dicarboxylic acid, there may be mentioned hexahydrophthalic acid. Examples of aromatic dicarboxylic acids include isophthalic acid, terephthalic acid, ortho-phthalic acid, tetrachlorophthalic acids and 1,5-naphthalenedicarboxylic acid. Among the unsaturated aliphatic dicarboxylic acids which may be used, there may be mentioned fumaric acid, maleic acid, itaconic acid, citraconic acid, mesaconic acid and tetrahydrophthalic acid. Examples of tri- and tetracarboxylic acids include trimellitic acid, trimesic acid and pyromellitic acid.

The polyhydric alcohols which may be used for the preparation of the polyester polyols include ethylene glycol, propylene glycol, 1,3-propanediol, 1,3-butanediol, 1,4-butanediol, 1,5-pentanediol, 1,6-hexanediol, neopentyl glycol, diethylene glycol, dipropylene glycol, triethylene glycol, tetraethylene glycol, dibutylene glycol, 2-methyl-1,3-pentanediol, 2,2,4-trimethyl-1,3-pentanediol, 1,4-cyclohexanedimethanol, ethylene oxide adducts or propylene oxide adducts of bisphenol A or hydrogenated bisphenol A. Triols or tetraols such as trimethylolethane, trimethylolpropane, glycerine and pentaerythritol may also be used. These polyhydric alcohols are generally used to prepare the polyester polyols by polycondensation with the above mentioned polycarboxylic acids, but according to a particular embodiment they can also be added as such to the reaction mixture.

Suitable polyether polyols include polyethylene glycols, polypropylene glycols and polytetraethylene glycols.

Suitable polycarbonate polyols which may be used include the reaction products of diols such as 1,3-propanediol, 1,4-butanediol, 1,6-hexanediol, diethylene glycol, triethylene glycol or tetraethylene glycol with phosgene, with diarylcarbonates such as diphenylcarbonate or with cyclic carbonates such as ethylene and/or propylene carbonate.

Suitable polyacetal polyols which may be used include those prepared by reacting glycols such as diethyleneglycol with formaldehyde. Suitable polyacetals may also be prepared by polymerizing cyclic acetals.

The active hydrogen-containing chain extender which may optionally be used is suitably an aliphatic, alicyclic, aromatic or heterocyclic primary or secondary polyamine having up to 80, preferably up to 12 carbon atoms, or water. In the latter case, a fully reacted polyurethane polymer is obtained with no residual free isocyanate groups.

Where the chain extension of the polyurethane prepolymer is effected with a polyamine, the total amount of polyamine should be calculated according to the amount of isocyanate groups present in the polyurethane prepolymer in order to obtain a fully reacted polyurethane urea polymer with no residual free isocyanate groups; the polyamine used in this case has an average functionality of 2 to 4, preferably 2 to 3.

The degree of non-linearity of polyurethane urea polymers controlled by the functionality of the polyamine used for the chain extension. The desired functionality can be achieved by mixing polyamines with different amine functionalities. For example, a functionality of 2.5 may be achieved by using equimolar mixtures of diamines and triamines.

Examples of such chain extenders useful herein include hydrazine, ethylene diamine, piperazine, diethylene triamine, triethylene tetramine, tetraethylene pentamine, pentaethylene hexamine, N,N,N-tris(2-aminoethyl)amine, N-(2-piperazinoethyl)ethylenediamine, N,N′-bis(2-aminoethyl)piperazine, N,N,N′-tris(2-aminoethyl)ethylenediamine, N-[N-(2-aminoethyl)-2-aminoethyl-N′-(2-aminoethyl)piperazine, N-(2-aminoethyl)-N′-(2piperazinoethyl)ethylene diamine, N,N-bis(2-aminoethyl)-N-(2-piperazinoethyl)amine, N,N-bis(2piperazinoethyl)amine, guanidine, melamine,N-(2-aminoethyl)-1,3-propanediamine, 3,3″-diaminobenzidine, 2,4,6-triaminopyrimidine, dipropylenetriamine, tetrapropylenepentamine, tripropylenetetramine, N,N-bis(6-aminohexyl)amine, N,N′-bis(3-aminopropyl)ethyienediamine, 2,4-bis(4′-aminobenzyl)aniline, 1,4-butanediamine, 1,6-hexanediamine, 1,8-octanediamine, 1,10-decanediamine, 2-methylpentamethylenediamine, 1,12-dodecanediamine, isophorone diamine (or 1-amino-3-aminomethyl-3 ′5,5-trimethylcyclohexane), bis(4aminocyclohexyl)methane (or bis(aminocyclohexane-4-yl)methane) and bis(4-amino-3-methylcyclohexyl)methane (or bis(amino-2-methylcyclohexane-4-yl)methane), polyethylene imines, polyoxyethylene amines and/or polyoxypropylene amines (e.g. Jeffamines from TEXACO).

The total amount of polyamines should be calculated according to the amount of isocyanate groups present in the polyurethane prepolymer. The ratio of isocyanate groups in the prepolymer to active hydrogen in the chain extender during the chain extension is in the range of from about 1.0:0.7 to about 1.0:1.1, preferably from about 1.0:0.9 to about 1.0:1.02 on an equivalent basis.

Preferably, the polyisocyanate is a diisocyanate and more preferably it is selected from 1,1′-methylenebis[4-isocyanatobenzene] and 1,1′-methylenebis[4-isocyanatocyclohexane].

Preferably the polyol is a polyethylene glycol selected from ethylene glycol, polyethylene glycol, polytetramethylene glycol and the like, eventually in admixture with other polyether polyols.

Preferably the chain extender is isophorone diamine (or 1-amino-3-aminomethyl-3,5,5,trimethylcyclohexane) alone or in admixture with hydrazine.

The reflective matter in the coating layer is preferably a dispersion of a pigment, such as a metal pigment or a pigment which presents a reflective metallic surface.

A wide range of metals may be used including, but not confined to, aluminium, bronze, stainless steel, brass, gold, nickel, silver, tin, copper or mixtures thereof. Alternatively mineral pigments such as glass or mica coated with reflective metal surfaces may be used. The reflective matter is preferably in a flake or platelet form.

The emissivity of the low emissivity layer for any particular reflective matter and coating is primarily dependent upon two variables: the amount of reflective matter present in the coating; and the thickness of the coating. Higher levels of reflective matter will give lower emissivities but increased cost, and above critical addition levels the matter may be insufficiently bound within the polymeric matrix.

Expressing the amount of reflective matter or pigment as a pigment to binder ratio, the pigment: binder ratio may be in the range from 3:1 to 1:10. The term “binder” is used to mean the dry or solvent-less polymer matrix forming the coating within which the pigment is dispersed. Coatings having lower pigment to binder ratios may still provide suitable low emissivity surfaces by increasing the coating layer weight per unit area which may preferably range from 0.8 g/m² to 2.5 g/m².

In order more readily to meet the strength requirements for cargo covers, the outer film layer is laminated to a support layer, i.e. a support layer having a strength which is greater than that of the substrate layer. The support layer may in particular have a greater tensile and/or tear strength than the outer layer.

The support layer may conveniently be laminated to the substrate by intermittent adhesive bonding.

The support layer may advantageously comprise a fabric, in particular a non-woven fabric. In an embodiment, the support layer comprises a polymeric spunbond, in particular a polypropylene spunbond. Suitably the spunbond has a basis weight in the range of from 10 to 100 g/m², in particular in the range of from 30 to 70 g/m².

Advantageously, the support may have one or more reflective or low emissivity surfaces.

Suitably, the support layer may comprise a highly reflective material, such as a pigment. Conveniently, the support layer may comprise a white pigment. In an embodiment the support layer has a white outer surface with a light reflectivity in the visible range (400-700 nm) of at least 70%, preferably at least 80% or even at least 90%.

In an embodiment, the support layer comprises a low-emissivity coating. Conveniently, the support layer may be metalised, preferably aluminised. Advantageously, the support layer may comprise a metalised or other low-emissivity coating on an inner surface, i.e. a surface facing towards cargo covered by the laminate in use.

To further enhance the thermal resistance of the insulation, the laminate may further comprise an insulation core comprising a fibrous wadding, the insulation core being sandwiched between the support layer and an inner convection barrier layer.

The fibrous wadding of the insulation core serves to entrap air, which is of course an excellent insulator provided that convection can be controlled. A suitable material for the wadding is, for example, polyethylene terephthalate (PET) fibre but a wide variety of materials may be used.

To counteract convection through the insulation core, the insulation core is sandwiched between the support layer and an inner convection barrier layer.

Advantageously, the insulation core may comprise a plurality of fibrous waddings interleaved with one or more internal convection barriers to restrict convection. Suitably the laminate may comprise two, three or four fibrous waddings interleaved with one, two or three convection barriers respectively.

It has been found that, in order to minimise convection within the insulation core, the (uncompressed) thickness of the or each fibrous wadding should be 15 mm or less, preferably 11 mm or less.

The inner convection barrier layer and any internal convection barriers may be of any suitable type to restrict mass movement of air. Advantageously, the convection barrier layer and/or any internal convection barriers may comprise a low-emissivity surface, e.g. a metallised or aluminised surface. In an embodiment the inner convection barrier layer comprises a non-woven spunbond having a metallised low-emissivity surface facing the insulation core.

The inner convection barrier layer and any internal convection barriers may be adhesively attached to neighbouring fibrous waddings, e.g. loosely by spots of adhesive.

The laminate may comprise a phase change material (“PCM”). Such materials can advantageously act as a temperature moderator. In particular, such materials can be used to store heat by causing a change in the “state” or “phase” of the materials, for example from a solid to a liquid.

By way of illustration, in a solid/liquid PCM, the heat applied to the PCM in a solid state is absorbed by the PCM resulting in an increase in the temperature of the PCM. As the temperature of the PCM reaches its phase change temperature, that is the temperature at which the PCM changes from a solid state to a liquid, the PCM stops increasing in temperature and substantially maintains a constant temperature at its phase change temperature, “consuming” the heat being applied thereto and storing it as latent heat. In reverse, as the PCM drops in temperature, the sensible heat which was consumed by the change to a liquid phase and stored as latent heat is released at the phase change temperature of the PCM as the PCM changes into its solid state. As before, the PCM maintains a substantially constant temperature at its phase change temperature while giving up the stored latent heat of liquification as it turns into its solid state.

Latent heat is the heat gained by a substance without any accompanying rise in temperature during a change of state. In essence, it is the amount of heat necessary to change a substance from one physical phase to another (more dis-ordered), for example, the the solid state to the liquid state. Once the phase change material has completely changed to the more dis-ordered phase, for example a liquid state, the temperature of the PCM begins to rise again as the applied heat is now absorbed as sensible heat.

The PCM comprises material that will change phase in a temperature range between an anticipated minimum temperature of cargo and an anticipated maximum temperature to which the cargo is exposed.

Suitably, the PCM may change phase at a temperature in the range of from 0 to 35° C., optionally in the range of from 2 to 30° C. In an embodiment the PCM may change phase at a temperature in the range of from 10 to 30° C., optionally in the range of from 15 to 25° C. In another embodiment, the PCM may change phase at a temperature in the range of from 0 to 10° C., optionally in the range of from 2 to 8° C.

The PCM may be selected from inorganic PCM and organic PCM.

Non-limiting examples of PCM include calcium chloride hexahydrate, glauber salt, paraffin (such as n-Tetradecane (C-14), n-Hexadecane (C-16), and n-Octadecane (C-18), olefin, Na₂ SO₄.10H₂O, CaCl₂.6H₂ O, NaHPO₄.12H₂ O, Na₂ S₂O₃.5H₂ O and NaCO₃.10H₂ O, and other materials compatible with the function and purpose of the invention disclosed herein. Heat and Cold Storage with PCM, Mehling, H; Cabeza, L.F, ISBN: 978-3-540-68556-2 provides information on various PCMs and phase change temperatures.

One example of an organic PCM with a phase change temperature of about 21° C. is CrodaTherm™ 21, available from Croda Industrial Chemicals.

To preserve the vapour permeability of the laminate, the PCM may be incorporated in a dispersed or intermittent manner. Suitably, the laminate may comprise a plurality of discrete amounts of PCM.

Suitably the laminate may comprise a PCM layer. Discrete amounts of PCM may be distributed, preferably substantially evenly, within the PCM layer. The PCM layer may optionally be adjacent the inner convection barrier layer.

The discrete amounts of PCM may, for example, be encapsulated in a liquid impermeable material, e.g. in a plurality of cells, and/or soaked into an absorbent material. The PCM layer may comprise a vapour permeable support layer bearing discrete amounts of PCM, for example in the form of discrete cells of PCM.

Additionally or alternatively the PCM may be applied to suitably absorbent fibres. Suitable fibres might be woven or nonwoven. The advantage of such a process would be that the layer retains much of its breathability, there being no need for vapour impermeable encapsulation. PCM could be applied by spraying onto the fibres or by dipping the fibres in a PCM solution. The fibres could be any synthetic or natural fibre able to absorb the PCM. By way of example, polyolefin fibres absorb PCM comprised of hydrocarbons, such as paraffin wax. The PCM layer may thus be a layer of absorbent fibres bearing PCM.

The vapour permeable laminate may comprise an overlap or overhang and/or an adhesive strip for affixing the laminate to a neighbouring laminate. Conveniently, an overhang may be formed by the outer layer.

Some aspects of the invention relate to cargo cover laminates comprising an exposed low-emissivity surface and a convection-restricted insulation core.

Thus, a further aspect of the invention provides a flexible, vapour impermeable cargo cover laminate comprising: a vapour impermeable outer layer comprising an exposed low-emissivity surface on an outward face of the outer layer; an inner convection barrier layer; and optionally an insulation core comprising a fibrous wadding, the insulation core being sandwiched between the outer and inner layers.

Such an impermeable laminate has the advantage that implementation of the exposed low-emissivity surface is greatly facilitated because this surface is not required to be vapour permeable. Compared to an exposed moisture vapour permeable low-emissivity surface, this may reduce costs, reduce the level of emissivity that are achievable, or both.

The low-emissivity surface may suitably have an emissivity of less than 0.5, preferably less than 0.2, more preferably less than 0.1 and most preferably less than 0.05.

Conveniently, the outer layer of the vapour impermeable laminate may comprises a metallic or metallised film. Optionally, the outer layer of the vapour impermeable laminate may be laminated to a support layer, for example a nonwoven fabric.

Suitably, the inner convection barrier layer and any internal convection barriers may be as described above in respect of the vapour permeable laminate.

The insulation core may be as described in respect of the vapour permeable laminate. For example the insulation core may comprise a plurality of fibrous waddings interleaved with one or more internal convection barriers to restrict convection. Suitably the laminate may comprise two, three or four fibrous waddings. The (uncompressed) thickness of the or each fibrous wadding may advantageously be 15 mm or less, preferably 11 mm or less.

The vapour impermeable laminate may comprise a phase change material (“PCM”). The PCM may be as described hereinabove in respect of the vapour permeable laminate.

The vapour impermeable laminate may comprise a PCM layer. The PCM layer may comprise discrete or intermittent amounts of PCM as described above in respect of the vapour permeable laminate. Alternatively, since vapour permeability is not of concern in the vapour impermeable laminate, the PCM layer of the impermeable laminate may comprise a continuous layer of PCM, for example a continuous, liquid impermeable cell containing PCM.

The vapour impermeable laminate may comprise an overlap or overhang and/or an adhesive strip for affixing the laminate to a neighbouring laminate. Conveniently, an overhang may be formed by the outer layer.

Some aspects of the invention relate to cargo covers comprising one or more cargo cover laminates according to the invention.

Thus, another aspect of the invention provides a cargo cover comprising a plurality of flexible insulation laminates, each laminate being joined to, or arranged to be joined to, at least one other of the laminates, wherein at least one of the laminates is a cargo cover laminate according to any aspect or embodiment of the invention herein.

Some aspects of the invention relate to a cargo cover comprising a plurality of different flexible insulation laminates.

Thus, yet another aspect of the invention provides a cargo cover comprising: a first flexible insulation laminate for covering a first part of the cargo, the first laminate comprising a first arrangement of layers; and a second flexible insulation laminate for covering a second part of the cargo, the second laminate comprising a second arrangement of layers which is different from the first arrangement of layers, the first laminate being joined to, or arranged to be joined to, the second laminate.

Optionally, the cargo cover may comprise one or more further flexible insulation laminates for covering one or more further parts of the cargo, said one or more further laminates comprising further arrangements of layers different from the first and second arrangements of layers and being joined to, or arranged to be joined to, at least one of the first and second laminates.

Optionally, the cargo cover may comprise a plurality of first laminates and/or a plurality of second laminates.

The first, second or further flexible insulation laminates may each independently comprise a cargo cover laminate according to any aspect or embodiment of the invention herein.

Suitably, the first flexible insulation laminate may be arranged to cover a top of the cargo, e.g. the top of a pallet of cargo. Additionally or alternatively, the second flexible insulation laminate may be arranged to cover a side of the cargo. Suitably, the second flexible insulation laminate may be arranged to cover four sides of a pallet of cargo.

Advantageously, the first flexible insulation laminate may be arranged to cover a top of the cargo and comprises a vapour permeable laminate according to any aspect or embodiment of the invention herein.

Optionally, the second flexible insulation laminate may be arranged to cover a side of the cargo and comprise a vapour permeable laminate or a vapour impermeable laminate according to any aspect or embodiment of the invention herein.

In an embodiment, the cargo cover comprises: a first flexible insulation laminate for covering a top of the cargo, the first laminate being a vapour permeable laminate, e.g. according to any aspect or embodiment of the invention herein; and a second flexible insulation laminate for covering a side of the cargo, the second laminate being a vapour permeable or vapour impermeable laminate, e.g. according to any aspect or embodiment of the invention herein, each laminate of the cargo cover being joined to, or arranged to be joined to, at least one of the other laminates.

Conveniently, the first flexible insulation laminate may have a higher thermal resistance than the second flexible insulation laminate. In this way the cargo cover can provide additional insulation where it is most required, i.e. at the top where environmental exposure is greatest.

A cargo cover in accordance with any aspect of the invention may simply be sheet-like. However, preferably, the cargo cover may be arranged to form a cavity for receiving cargo. In particular, the cargo cover may be cap-shaped, in particular box-shaped, to receive and fit snugly over a pallet of cargo. In particular, the cargo cover may be generally oblong or square in plan, with four sides, a top and a bottom opening for receiving cargo.

The cargo cover laminates may comprise fixing means for being fixed together. Advantageously, the cargo cover laminates may comprise an overlap or overhang and/or an adhesive strip for affixing the laminate to a neighbouring laminate. For example, a first insulation laminate covering a top of the cargo may overlap a second insulation laminate covering a side of the cargo in a cap-like manner, or the second insulation laminate may overlap the top.

In an embodiment, at least some (and preferably all) of the cargo cover laminates of the cargo cover are joined together before deployment on cargo, using any joining system such as double-sided adhesive tape, adhesives such as hot melt or stitching. Seals between the laminates should be suitably water-tight to prevent ingress into the cover. Additionally or alternatively the cargo cover laminates can be joined together in-situ.

In an embodiment, two ends of a cargo cover laminate are joined together to form a side wrap of the cargo cover. The wrap may subsequently be combined with a top formed from another cargo cover laminate.

The cargo cover may include, or be co-operable with, an insulation base. Suitably, the insulation base may comprise a cargo cover laminate according to any aspect or embodiment of the invention. Conveniently, the base may comprise an impermeable cargo cover laminate, e.g. according to any aspect or embodiment of the invention.

Cargo cover laminates comprising an insulation core with a fibrous wadding are of particular benefit as the insulation base. In particular, the insulation core may be compressed to allow feet of the cargo to stand firmly on the base but opens up resiliently between feet to entrap air and increase the thermal resistance of the base.

The insulation base may comprise fixing means for being fixed to cargo cover laminates of the cargo cover. Advantageously, the base may comprise an overlap or overhang and/or an adhesive strip for affixing the base to a neighbouring laminate. For example, the base may overlap a second insulation laminate covering a side of the cargo in a cap-like manner, or the second insulation laminate may overlap the base.

In an embodiment, the cargo cover may include a PCM layer. The PCM layer may comprise discrete or intermittent amounts of PCM as described above in respect of the vapour permeable laminate. Alternatively, the PCM layer may comprise a continuous layer of PCM, for example a continuous, liquid impermeable cell containing PCM. In some embodiments the first flexible insulation laminate may comprise the PCM layer. That is, the PCM layer may be arranged to cover the first part of the cargo. The second flexible insulation laminate may include substantially no PCM layer.

In preferred embodiments the phase change material layer includes a flexible insulation material comprising a flexible porous medium defining a pore volume, and a phase change material (PCM) within the pore volume.

Some aspects of the invention relate to methods of making cargo covers.

Thus, another aspect of the invention provides a method of making a cargo cover for covering a cargo, the method comprising the steps of: forming a first layer arranged to cover at least a portion of the cargo; arranging a layer of phase change material on the first layer; and forming a second layer over the layer of phase change material to sandwich the phase change material between the first and second layers.

This arrangement provides a relatively simple and straightforward method of manufacturing a cargo cover. Moreover, this method provides for complete visibility of the position of the phase change material relative to the first layer. That is, since the phase change material is applied prior to the second layer the location of the phase change material can be readily determined. This provides not only for ease of manufacture, but also enables gaps between regions of phase change material to be eliminated or minimised, thus minimising the risk of thermal bypass of the phase change material.

In preferred embodiments the method includes the step of attaching the layer of phase change material to the first layer prior to forming the second layer. Thus, the position of the phase change material is further controlled.

The step of forming the first layer may comprise arranging a sheet of material over a former. For example, the former may approximate a shape and size of the cargo to be covered by the cargo cover. In some embodiments the former may generally be cube shaped. However, it may be alternatively be rectangular prism or any other suitable shape. The former may be made of any suitable material, for example such as wood, metal or plastic. By using a former in this way the first layer may be readily formed to provide the base shape of the cargo cover, i.e. the base shell or template of the cargo cover.

In preferred embodiments the step of forming the first layer comprises forming a first portion for covering a first part of the cargo and a second portion for covering a second part of the cargo. The first portion may comprise the same material as the second portion, or in other embodiments may comprise different materials. For example, the first portion may comprise a flexible vapour permeable cargo cover laminate as described herein, and/or the second portion may comprise a flexible vapour impermeable cargo cover laminate as described herein, or vice versa.

The step of arranging a layer of phase change material on the first layer preferably includes providing the phase change material on the first and/or second portions of the first layer. The phase change material may overlay substantially the whole first portion and/or substantially the whole second portion, and/or may overlay only a portion of the first and/or second portions.

In preferred embodiments the first portion of the first layer comprises a top face for covering an upper part of the cargo and the second portion of the first layer comprises one or more side walls for covering one or more sides of the cargo. In some embodiments the cargo cover may be generally box-shaped or cuboid-shaped such that the second portion comprises four side walls.

The step of forming the second layer preferably comprises overlaying substantially the whole layer of phase change material, optionally extending beyond a perimeter of the layer of phase change material. Thus, the second layer protects the phase change material layer and provides an aesthetically pleasing finish. By extending the second layer beyond a perimeter of the layer of phase change material an overhang or overlap region is provided.

The method may include the step of attaching the second layer to the first layer to sandwich the phase change material between the first and second layers. In embodiments in which the second layer is extended beyond a perimeter of the layer of phase change material the resulting overhang or overlap region facilitates attachment of the second layer to the first layer. The attachment can be achieved in any technically desirable way, for example using an adhesive or adhesive tapes.

The first and/or second layers may comprise a flexible insulation laminate. For example, the first and/or second layers may comprise a flexible insulation laminate or cargo cover laminate as disclosed herein.

In preferred embodiments the phase change material layer includes a flexible insulation material comprising a flexible porous medium defining a pore volume, and a phase change material (PCM) within the pore volume. Such an arrangement can mitigate or prevent pooling of the PCM. Moreover, such an arrangement may allow for flexing of the phase change material layer when the phase change material is in a solid state. This provides an advantage over known arrangements in which flexing of a PCM material in a solid state is not possible.

In a related aspect, the invention provides a cargo cover for covering a cargo, the cargo cover comprising a laminate including: a first layer arranged to cover at least a portion of the cargo; a layer of phase change material arranged on the first layer; and a second layer overlaying the layer of phase change material such that the phase change material is sandwiched between the first and second layers.

The cargo cover may be manufactured according to the method of manufacture described above. Features of the cargo cover disclosed above in relation to the method of manufacture can be applied to the cargo cover itself, either singly or in any combination.

Such a cargo cover may be relatively straightforward to manufacture without gaps between regions of phase change material, thus minimising the risk of thermal bypass of the phase change material.

In preferred embodiments the layer of phase change material is attached to the first layer. Thus, the position of the phase change material is further controlled.

The first layer may comprise a first portion for covering a first part of the cargo and a second portion for covering a second part of the cargo. The first portion may comprise the same material as the second portion, or in other embodiments may comprise different materials. For example, the first portion may comprise a flexible vapour permeable cargo cover laminate as described herein, and/or the second portion may comprise a flexible vapour impermeable cargo cover laminate as described herein, or vice versa.

The layer of phase change material is preferably provided on the first and/or second portions of the first layer. The phase change material may overlay substantially the whole first portion and/or substantially the whole second portion, and/or may overlay only a portion of the first and/or second portions.

In preferred embodiments the first portion of the first layer comprises a top face for covering an upper part of the cargo and the second portion of the first layer comprises one or more side walls for covering one or more sides of the cargo. In some embodiments the cargo cover may be generally box-shaped or cuboid-shaped such that the second portion comprises four side walls.

Preferably the second layer substantially overlays the whole layer of phase change material, optionally extending beyond a perimeter of the layer of phase change material, optionally to form an overhang or overlap portion for affixing the second layer to the first layer. Thus, the second layer protects the phase change material layer and provides an aesthetically pleasing finish. By extending the second layer beyond a perimeter of the layer of phase change material an overhang or overlap region is provided.

The second layer may be attached to the first layer to sandwich the phase change material between the first and second layers. In embodiments in which the second layer is extended beyond a perimeter of the layer of phase change material the resulting overhang or overlap region facilitates attachment of the second layer to the first layer. The attachment can be achieved in any technically desirable way, for example using an adhesive or adhesive tapes.

The first and/or second layers may comprise a flexible insulation laminate. For example, the first and/or second layers may comprise a flexible insulation laminate or cargo cover laminate as disclosed herein.

In preferred embodiments the phase change material layer includes a flexible insulation material comprising a flexible porous medium defining a pore volume, and a phase change material (PCM) within the pore volume. Such an arrangement can mitigate or prevent pooling of the PCM. Moreover, such an arrangement may allow for flexing of the phase change material layer when the phase change material is in a solid state. This provides an advantage over known arrangements in which flexing of a PCM material in a solid state is not possible.

Still another aspect of the invention provides a method of making a cargo cover for covering a cargo, the method comprising the steps of: forming a first flexible insulation laminate for covering a first part of the cargo, the first laminate comprising a first arrangement of layers; forming a second flexible insulation laminate for covering a second part of the cargo, the second laminate comprising a second arrangement of layers which is different from the first arrangement of layers; and joining the first laminate to the second laminate.

In an embodiment, the step of forming the first and/or second flexible insulation laminate may comprise forming a hollow tube from a sheet of flexible insulation laminate. The hollow tube may, for example, be formed by wrapping the sheet of flexible insulation laminate around a former. In such embodiments, the sheet of flexible insulation laminate is suitably longer in length than the perimeter of the former, so that when the flexible insulation laminate is wrapped around the former, a portion of the flexible insulation laminate overlaps. The flexible insulation laminate may be adhered to itself along the overlapping portion, for example using double sided tape or an adhesive.

In some embodiments, the method may comprise the step of applying a layer of PCM to one or more sides of the first and/or second flexible laminate. The PCM layer may comprise discrete or intermittent amounts of PCM. Alternatively, the PCM layer may comprise a continuous layer of PCM covering a portion or the whole of the one or more sides of the first and/or second flexible laminate. In some embodiments the first flexible insulation laminate may comprise the PCM layer. That is, the PCM layer may be arranged to cover the first part of the cargo. The second flexible insulation laminate may include substantially no PCM layer. That is, the PCM layer may be comprised in the first flexible insulation laminate only, to optionally cover the first part of the cargo, which may comprise a top of the cargo.

Where the method involves the applying a layer of PCM to one or more sides of the first and/or second flexible laminate, the method may also comprise the step of forming a third flexible insulation laminate covering the PCM layer. The third flexible insulation laminate may advantageously be made from the same material as the first and/or second flexible insulation laminates. Thus the PCM layer may conveniently be sandwiched between first and/or second flexible insulation laminates and the third flexible insulation laminates.

In preferred embodiments the phase change material layer includes a flexible insulation material comprising a flexible porous medium defining a pore volume, and a phase change material (PCM) within the pore volume. Such an arrangement can mitigate or prevent pooling of the PCM. Moreover, such an arrangement may allow for flexing of the phase change material layer when the phase change material is in a solid state. This provides an advantage over known arrangements in which flexing of a PCM material in a solid state is not possible.

In aspects of the invention in which the phase change material layer includes a flexible insulation material the following features may apply to the phase change material layer. The insulation material may be flexible in the sense that it has at least some ability to flex or bend. Different degrees of flexibility may be desirable for different applications.

Advantageously, in various embodiments, the flexible insulation material may be capable of bending under its own weight. A suitable method for determining whether a material can bend under its own weight is the Pierce cantilever test ASTM D1388.

In the Pierce cantilever test a specimen of the material to be tested is cut to 200 mm×25 mm. The sample is then gradually slid over the edge of a platform of a Pierce cantilever device. As the leading edge of the specimen projects from the platform, it may bend under its own weight, until the leading edge of the specimen makes contact with a sloping surface of the device angled downwards at an angle θ=41.5°. The overhanging length (l) of the specimen is measured using a graduated ruler. The measured length (l) is multiplied by a scaling factor to give a value for the bending stiffness (G) in Nm.

For the purposes of the present specification, a material can bend under its own weight if a leading edge of the material makes contact with the sloping surface in the Pierce cantilever test.

The insulation material may be flexible only in a certain state of the PCM. For example, the insulation material may be flexible, or even bend under its own weight, only when the PCM is in a liquid state.

Advantageously, it has been found in various embodiments of the invention that incorporation of the PCM into the pore volume of the porous medium may allow for flexing where the PCM is in a solid state and would otherwise break.

Advantageously, the insulation material may be flexible in all states of the PCM. For example, the insulation material may be flexible when the PCM is in a liquid state and when the PCM is in a solid state. Typically, different degrees of flexibility will be achieved in different PCM states. For example, the insulation material may bend under its own weight in the sense of the Pierce cantilever test when the PCM is in a liquid state and have a lower degree of flexibility when the PCM is in the solid state.

To enhance flexibility the PCM may advantageously fill only part of the pore volume, with a remaining part of the pore volume comprising air. In various embodiments, the phase change material may fill in the range of from 50 to 95% of the pore volume, in particular in the range of from 40 to 90% of the pore volume, such as in the range of from 50 to 85% of the pore volume. Optionally the remainder of the pore volume may be filled with air.

Suitably, to preserve air in the pore volume, the insulation material may be substantially uncompressed.

Conveniently, the insulation material may be air and/or vapour permeable. This may be of benefit, for example, where there is a desire to minimise condensation. It has been found that an air-open insulation material in which only part of the pore volume is filled by PCM can provide for both advantageous flexibility and permeability.

The insulation material may show air permeability in the sense that when the insulation material is subjected to a hydrostatic head of water and an air pressure in the region of 9 to 13 kPa is applied to the underside, bubbles can be seen in the water above the insulation material.

The porous medium may optionally comprise a layer. Suitably, the layer may have a thickness in the range of from 0.5 to 20 mm, such as in the range of from 1 to 5, e.g. in the range of from 1.5 to 3 mm.

Optionally, the porous medium may have a density (basis weight) greater than about 190 g/m², or of greater than about 200 g/m², or of greater than about 250 g/m², or of greater than about 270 g/m². The porous medium may have a density in the range of from 100 g/m² to 2500 g/m², such as in the range of from 100 g/m² to 2000 g/m², or in the range of from 150 g/m² to 1500 g/m², or in the range of from 150 g/m² to 1000 g/m², or in the range of from 150 g/m² to 750 g/m², or in the range of from 190 g/m² to 500 g/m², or in the range of from 190 g/m² to 350 g/m², or in the range of from 200 g/m² to 300 g/m², or in the range of from 250 g/m² to 300 g/m².

Advantageously, the porous medium may comprise fibres. To enhance absorption capacity, the fibres of the porous medium may have a relatively small diameter. Suitably the mean fibre diameter of the fibres may be the range of from 1 to 10 μm, or in the range of from 1 to 8 μm, or in the range of from 1 to 4 μm, or in the range of from 1 to 3 μm, for example such as about 1 μm, or about 2 μm, or about 3 μm.

The amount of phase change material able to be absorbed and held within a fibrous porous medium is dependent on the total fibre surface area, which in turn is dependent on the mean fibre diameter of the fibres and the density of the porous medium. The greater the total fibre surface area, the greater the amount of phase change material that can held within the fibrous porous medium.

The porous medium may in principle be made of any suitable material but may conveniently comprise a synthetic material. Conveniently, the porous medium may be polymeric, i.e. comprise or consist of one or more polymers (or copolymers).

In various embodiments, the porous medium comprises a polyolefin, optionally polypropylene.

Suitably, the porous medium may comprises a non-woven material. A variety of such materials are known. In various embodiments, melt-blown material has been found to provide particularly effective absorption of PCMs.

The PCM may be of any suitable type. A wide range of PCMs are known in the art. Such materials can advantageously act as a temperature moderator. In particular, such materials can be used to store heat by causing a change in the “state” or “phase” of the materials, for example from a solid to a liquid.

By way of illustration, in a solid/liquid PCM, the heat applied to the PCM in a solid state is absorbed by the PCM resulting in an increase in the temperature of the PCM. As the temperature of the PCM reaches its phase change temperature, that is the temperature at which the PCM changes from a solid state to a liquid, the PCM stops increasing in temperature and substantially maintains a constant temperature at its phase change temperature, “consuming” the heat being applied thereto and storing it as latent heat. In reverse, as the PCM drops in temperature, the sensible heat which was consumed by the change to a liquid phase and stored as latent heat is released at the phase change temperature of the PCM as the PCM changes into its solid state. As before, the PCM maintains a substantially constant temperature at its phase change temperature while giving up the stored latent heat of liquification as it turns into its solid state.

Latent heat is the heat gained by a substance without any accompanying rise in temperature during a change of state. In essence, it is the amount of heat necessary to change a substance from one physical phase to another (more dis-ordered), for example, the solid state to the liquid state. Once the phase change material has completely changed to the more dis-ordered phase, for example a liquid state, the temperature of the PCM begins to rise again as the applied heat is now absorbed as sensible heat.

In various embodiments of the invention, the PCM is organic. However, inorganic PCMs are also known and could suitably be used.

An organic PCM may, for example, comprise paraffin or a paraffin-derived hydrocarbon, a carbohydrate, a lipid, or a mixture thereof. Non-limiting examples of organic PCMs include n-tetradecane (C-14), n-hexadecane (C-16), and n-octadecane (C-18) and olefin.

Alternatively or additionally, the PCM may comprise an inorganic PCM such as an inorganic salt hydrate or eutectic material. Non-limiting examples of inorganic PCMs include calcium chloride hexahydrate, glauber salt, Na₂SO₄.10H₂O, CaCl₂.6H₂O, NaHPO₄.12H₂O, Na₂S₂O₃.5H₂O and NaCO₃.10H₂₀O. Heat and Cold Storage with PCM, Mehling, H; Cabeza, L. F, ISBN: 978-3-540-68556-2 provides information on various PCMs and phase change temperatures.

In various embodiments, the PCM is hydrophobic. For example, the PCM may comprise compounds having carbon chains of at least eight, ten or twelve carbon atoms.

One example of an organic, hydrophobic PCM with a phase change temperature of about 21° C. is CrodaTherm™ 21, available from Croda Industrial Chemicals.

The PCM comprises material that will change phase in a temperature range between an anticipated minimum temperature and an anticipated maximum temperature to be controlled by the insulation material. Suitably, the phase change may be between solid and liquid.

Suitably, the PCM may change phase at a temperature in the range of from −10 to 60° C., optionally in the range of from 2 to 30° C. In an embodiment the PCM may change phase at a temperature in the range of from 10 to 30° C., optionally in the range of from 15 to 25° C. In another embodiment, the PCM may change phase at a temperature in the range of from 0 to 10° C., optionally in the range of from 2 to 8° C.

Suitably the insulation material may constitute a PCM layer. Discrete amounts of PCM may be distributed, preferably substantially evenly, within a PCM layer.

Suitably, the PCM layer may have a thickness in the range of from 0.5 to 10 mm, such as in the range of from 1 to 5 mm, e.g. in the range of from 1.5. to 3 mm. Suitably, the insulation material may be presented as a sheet or a roll.

The flexible insulation material may be laminated with one or more supplementary layers to form an insulation laminate.

The supplementary layers, and indeed the insulation laminate as a whole, may advantageously be flexible, at least when the PCM is in a liquid state and optionally also when the PCM is in a solid state. Optionally, the insulation laminate may bend under its own weight in the sense of the Pierce test cited hereinabove.

Advantageously, the flexible insulation material may be sandwiched between first and second supplementary layers. Conveniently, the flexible insulation material may be surrounded by said one or more layers. This can assist in containing the PCM. Advantageously, the flexible insulation material may be encapsulated by the one or more supplementary layers. For example, the laminate may take the form of a pouch containing the flexible insulation material.

The one or more supplementary layers may comprise a barrier layer for resisting penetration of the PCM from the flexible insulation material layer out of the insulation laminate. A barrier layer may suitably comprise a monolithic or microporous film. Examples of monolithic films include cellulose, polyamide and ethylene vinyl alcohol, but a range of suitable films will be apparent to the skilled person.

To enhance insulation performance, the one or more supplementary layers may advantageously comprise a reflective layer having an emissivity of less than 0.5, preferably less than 0.3, more preferably less than 0.25 and most preferably less than 0.20. Suitably, such a reflective layer may comprise an outward-facing reflective surface that is exposed.

Optionally, a reflective layer may be vapour permeable, comprising a vapour permeable substrate bearing a coating having particles of infra-red reflective matter dispersed within a polymeric matrix and providing an exposed low-emissivity surface on an outward face of the reflective layer. Such vapour permeable reflective layers are described in WO 2009/024804.

The one or more supplementary layers may comprise a support layer. A support layer may, for example, comprise a fibrous woven or non-woven material. Suitably, a spunbond layer may be used as a support layer.

A support layer may suitably be laminated, e.g. by intermittent heat or adhesive bonding, to a barrier layer or reflective layer as described herein. Typically a support layer has a greater tensile and/or tear strength than the layer to which it is laminated.

In an embodiment, the one or more supplementary layers may comprise one or more air and/or vapour permeable layers. In particular, the one or more air and/or vapour permeable layers may have a moisture vapour transmission rate (MVTR) of at least 100 g/m².24 hr, e.g. at least 200 g/m².24 hr, or even at least 500 g/m².24 hr as determined using a Lyssy Model L80-5000 Water Vapor Permeability Tester at 100%/15% RH, i.e. 85% RH difference and 23° C. In various embodiments, the MVTR may be at most 2000 g/m².24 hr, e.g. at most 1500 g/m².24 hr, or even at most 1000 g/m².24 hr as determined using the aforementioned method.

Advantageously, the laminate may be air and/or vapour permeable. The laminate may, for example, have a moisture vapour transmission rate (MVTR) of at least 100 g/m².24 hr, e.g. at least 200 g/m². 24 hr, or even at least 500 g/m². 24 hr as determined using a Lyssy Model L80-5000 Water Vapor Permeability Tester at 100%/15% RH, i.e. 85% RH difference and 23° C. In various embodiments, the MVTR may be at most 2000 g/m². 24 hr, e.g. at most 1500 g/m². 24 hr, or even at most 1000 g/m². 24 hr as determined using the aforementioned method.

To contain the insulation material, one or more layers of the laminate may be sealed at one or more side edges of the laminate. The layers may be sealed at all edges of the laminate. A sealed pouch of the insulation material may advantageously be provided.

In some embodiments, at least one of the one or more layers of the insulation laminate may comprise a thermosetting polymer. Advantageously, this can allow the one or more layers to be heat sealed together to form seams.

Suitably, the insulation laminate may be presented as a sheet or a roll.

Some aspects of the invention relate to methods of insulating cargo covers.

Thus, still another aspect of the invention provides a method of insulating cargo, the method comprising covering the cargo with a cargo cover laminate or cargo cover according to any aspect or embodiment of the invention described herein.

In its simplest form, covering the cargo may comprise draping a sheet-like cargo cover laminate or cargo cover over the cargo.

The cargo may conveniently comprise a pallet of cargo that is oblong in plan. Preferably, covering the cargo may comprise placing a generally cap-shaped cargo cover over the pallet of cargo. The method may comprise pulling a pre-assembled cover, or partly pre-assembled cover over the pallet of cargo. The method may comprise assembling the cargo cover in-situ.

Optionally, the cargo may have a target temperature in the range of from 15 to 25° C. Alternatively, the cargo may have a target temperature in the range of from 2 to 8° C. Suitably, the cargo may comprise an insulated container with an internal target temperature in the range of from 2 to 8° C.

The method may comprise securing the cargo cover to the cargo.

Advantageously, the cargo may comprise a temperature-sensitive product. In an embodiment, the cargo comprises pharmaceuticals and/or perishable food.

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is a schematic sectional view of a cargo cover laminate in accordance with an embodiment of the invention;

FIG. 2 is a schematic sectional view of a cargo cover laminate in accordance with an embodiment of the invention;

FIG. 3 is a schematic sectional view of a cargo cover laminate in accordance with an embodiment of the invention;

FIG. 4 is a schematic sectional view of a cargo cover laminate in accordance with an embodiment of the invention;

FIG. 5 is a schematic sectional view of a cargo cover laminate in accordance with an embodiment of the invention;

FIG. 5A is a schematic sectional view of an optional PCM layer which may be added to the laminates of FIGS. 1 to 5;

FIG. 6A is a schematic plan view of a cargo cover top laminate of a cargo cover in accordance with an embodiment of the invention;

FIG. 6B is a perspective bottom view of a cargo cover side laminate of a cargo cover in accordance with an embodiment of the invention;

FIG. 6C is a schematic plan view of a base laminate of a cargo cover in accordance with an embodiment of the invention;

FIG. 7 is a schematic side sectional view of a cargo cover in accordance with an embodiment of the invention covering a palette of cargo; and

FIGS. 8A to 8M illustrate a method of assembling a cargo cover having four sides, a top comprising a PCM, and a bottom opening for receiving cargo, in accordance with an embodiment of the invention.

### DETAILED DESCRIPTION

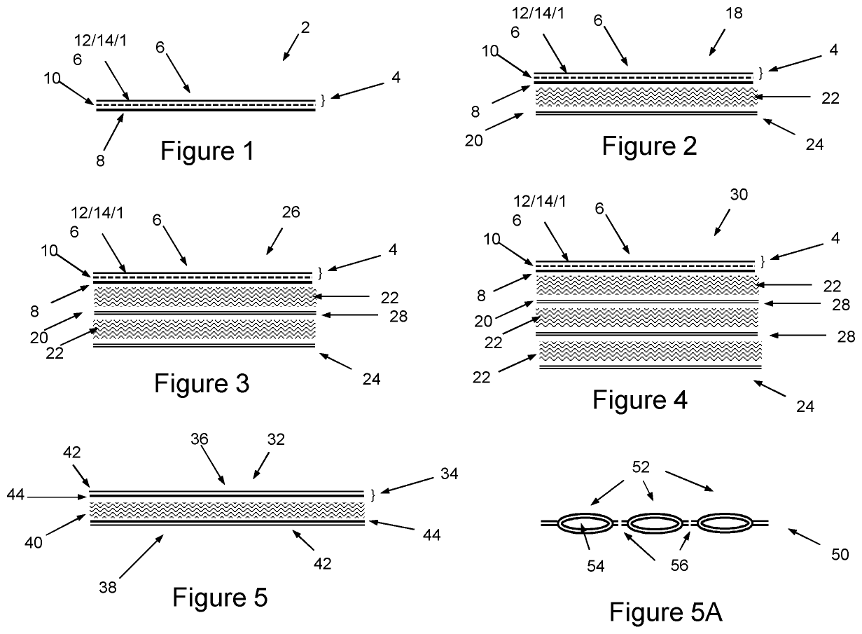

Referring firstly to FIG. 1, a first flexible, vapour permeable cargo cover laminate 2 comprises an outer layer 4 having an exposed low-emissivity surface 6 on an outward face of the outer layer 4; and a support layer 8 laminated to an inward face of the outer layer.

The outer layer 4 is liquid water impermeable but water vapour permeable, comprising a substrate 10 bearing a coating 12 having particles of infra-red reflective matter 14 dispersed within a polymeric 16 matrix to provide the low-emissivity surface

The substrate of the outer layer is a microporous polypropylene film (ex Lensing) having a thickness of about 30 μm. The coating comprises a polymer matrix formed of a hydrophilic, breathable polyurethane, specifically a solvent-based aliphatic polyurethane.

Dispersed within the polymer matrix are particles of infra-red reflective matter, specifically aluminium platelets or “Silver dollar” grade aluminium with a particle diameter from about 2 μm to about 50 μm.

The particle to matrix ratio within the coating is approximately 1 and the coating has been applied to the substrate by gravure coating.

The coating is applied to an exposed outer side of the substrate and provides an emissivity of about 0.16. The MVTR of the outer layer is about 170 g/m².day.

The support layer is a white polypropylene spunbond with a weight of about 50 g/m² and an aluminised side facing away from the outer layer. The support layer is adhesively bonded to an inner side of the substrate, opposed to the outer side bearing the coating. To preserve the vapour permeability of the laminate, the bonding is intermittent.

The MVTR of the laminate as a whole is about 70 g/m².day.

Referring now to FIG. 2, a second flexible, vapour permeable cargo cover laminate 18 comprises an outer layer as described in respect of the laminate of FIG. 1 (save that the support layer is non-aluminised) an insulation core 20 comprising a fibrous PET wadding 22, and an inner convection barrier layer 24. Like reference numerals are used for like parts.

The fibrous PET wadding has a weight of about 190 g/m² and a thickness of about 11 mm. The fibrous wadding is bonded by spots of adhesive to the support layer and the inner convection barrier layer. In this manner the outer layer and the inner convection barrier layer sandwich the insulation core.

The inner convection barrier layer is a white polypropylene spunbond with a weight of about 50 g/m² and an exposed, inner aluminised side facing away from the wadding. The second laminate has an R value of about 0.3 m²·K/W.

Referring now to FIG. 3, a third flexible, vapour permeable cargo cover 26 laminate is identical to the laminate of FIG. 2 save that the insulation core comprises first and second ones of the fibrous PET waddings separated by an internal convection barrier 28. The convection barrier is a white polypropylene spunbond with a weight of about 50 g/m², aluminised on one side.

The third laminate has an R value of about 0.6 m²·K/W.

Referring now to FIG. 4, a fourth flexible, vapour permeable cargo cover 30 laminate is identical to the laminate of FIG. 3 save that the insulation core comprises first, second and third ones of the fibrous PET waddings, separated by two of the internal convection barriers, and in that the substrate of the outer layer comprises a cellulose acetate film having a thickness of about 20 μm adhesively laminated to a 50g/m² black PP spunbond.

The third laminate has an R value of about 0.9 m²·K/W.

Referring now to FIG. 5, a fifth vapour impermeable flexible laminate for insulating cargo 32 comprises a vapour impermeable outer layer 34 having an exposed low-emissivity surface 36 on an outward face; an inner convection barrier layer 38; and an insulation core 40 comprising a fibrous wadding sandwiched between the outer and inner layers.

The outer layer is liquid water and vapour impermeable comprising an aluminised cast polypropylene film 42 adhesively laminated to a 40 g/m² polypropylene spunbond 44. The aluminised film is on the outer side of the laminate and presents a low emissivity surface providing an emissivity of equal to or less than 0.05.

The inner convection barrier layer is identical to the outer layer, comprising an aluminised cast polypropylene film adhesively laminated to a 40 g/m² polypropylene spunbond. The spunbond lies between the aluminised film and the wadding.

The fifth laminate has an R value of about 0.3 m²·K/W and is vapour impermeable.

Each of the first to fifth laminates may optionally be modified to include a phase change material (PCM) layer. With reference to FIG. 5A, one suitable phase change material layer 50 comprises two polymeric sheets joined in such a way as to create cells 52 containing PCM 54 in a liquid state so that the PCM 54 does not move from its location. To provide for vapour permeability, the sheets of the PCM layer comprise a plurality of micro-perforations 56 between the cells 52 containing PCM 54. In other embodiments the PCM layer may be provided in a continuous layer, without cells 52.

In the first to fourth laminates, the PCM layer 50 can, for example, replace one of the convection inhibiting layers 28, or form an additional layer between a fibrous wadding 22 and the inner convection barrier layer 24 or an internal convection barrier layer 28.

In the fifth laminate, the PCM layer 50 can, for example, form an additional layer between the insulation core 40 and the inner layer 38. As the fifth laminate is vapour impermeable, the PCM layer 50 is not required to comprise micro-perforations.

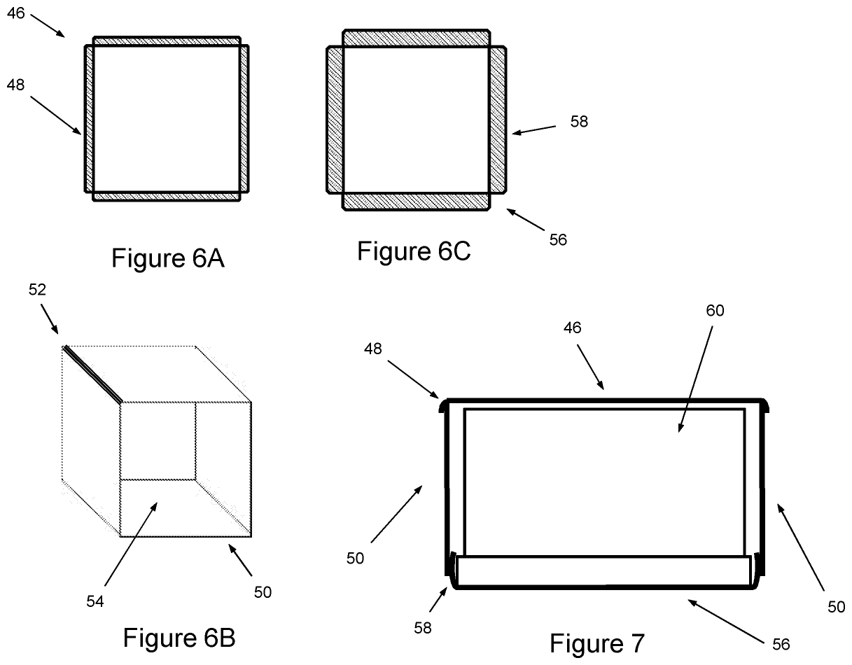

Referring now to FIGS. 6A to 6C and FIG. 7, the laminates of FIGS. 1 to 5 (without any PCM layer 50) were incorporated into a range of cargo covers.

With reference to FIG. 6A, the cargo covers each comprised a top laminate 46 which was generally square in plan with overhangs 48 of the outer layer at its boundary.

With reference to FIG. 6B, the cargo covers each comprised a side laminate 50 which was generally oblong in plan, joined at two short ends along a seam 52 and creased to form a wrap structure defining a cavity 54 for receiving a pallet of cargo.

With reference to FIG. 6C, an insulation base 56 was optionally provided for use with some cargo covers. The insulation base was generally square in plan with overhangs 58 of the outer layer at its boundary.

With reference to FIG. 7 the cargo covers were fully assembled by taping the top laminate 46 to the side laminate 50 with double-adhesive tape along the overhang 48. Thereafter, a pallet of cargo 60 was covered with the covers. Where an insulation base 56 was used, this was placed under the pallet side laminate taped over the top of the overhang 58 of the base.

Each cargo cover was tested in finished cover form by placing it over a pallet of boxes of known average bulk density and then determining the time taken for the contents of the pallet boxes to increase in temperature from a defined start temperature to a defined higher finish temperature, the start and finish temperatures being those accepted by the industry users i.e. the end customers responsible for manufacturing and shipping the goods. The pallet was built up with plastic bottles containing water for higher density testing (target density 0.2 kg/m³) as follows:
Standard Euro pallet (1.2 m×0.8 m)
24 Double skin cardboard boxes used per pallet (Dimensions L400 mm×W400 mm×H300 mm)
Pallet was built in layers of 6 Boxes (3×2) to a height of 4 boxes
Each box contained 12×500 ml bottles of water

The test pallet was fitted with temperature probes to give temperature readings at key positions inside the boxes from the bottom to the top of the pallet. Measurements were made at the top corner, top centre and bottom corner of the pallet.

The temperature probes were connected to data loggers to record the temperatures at frequent intervals throughout the test procedure. The cargo cover to be tested was fitted over the test pallet and the whole (wooden pallet base, boxes plus temperature probes, cargo cover) placed in a controlled temperature conditioning chamber to achieve a target start temperature for the test (in this case, 18° C.±1.0° C.). Once the target start temperature has been achieved, the covered test pallet is moved quickly into a heated test chamber set at 45° C. The temperatures at the various positions within the palletised boxes were then monitored and the times to achieve a temperature increases from 18° C. to 25° C. were measured.

Table 1 provides details the examples of cargo covers that were made in this manner from the laminates of FIGS. 1 to 5, as well as the results of the tests (where available).

TABLE 1

| | | | | Top | Top | Bottom |
|---|---|---|---|---|---|---|
| | | | | Corner | Centre | corner |
| | | | | Time | Time | Time |
| Cargo | Top | Side | Base | to 25° C. | to 25° C. | to 25° C. |
| Cover | laminate | laminate | laminate | (mins:sec) | (mins:sec) | (mins:sec) |
| Ex 1 | FIG. 1 | FIG. 1 | FIG. 3 | — | — | — |
| Ex 2 | FIG. 2 | FIG. 2 | FIG. 3 | 06:43 | 06:41 | 09:25 |
| Ex 3 | FIG. 3 | FIG. 3 | FIG. 3 | 07:49 | 08:58 | 09:18 |
| Ex 4 | FIG. 1 | FIG. 1 | none | — | — | — |
| Ex 5 | FIG. 2 | FIG. 2 | none | 05:51 | 06:23 | 05:54 |
| Ex 6 | FIG. 3 | FIG. 3 | none | 06:38 | 05:52 | 05:00 |
| Ex 7 | FIG. 4 | FIG. 5 | FIG. 5 | 07:03 | 09:07 | 09:55 |
| Ex 8 | FIG. 5 | FIG. 5 | FIG. 5 | 06:02 | 06:08 | 08:16 |

These results demonstrate that the example cargo covers are effective in protecting cargo from environmental temperature variations for several minutes.

It will be appreciated that the particular cargo cover laminates and cargo covers exemplified can be readily modified without departing from the scope of the invention.

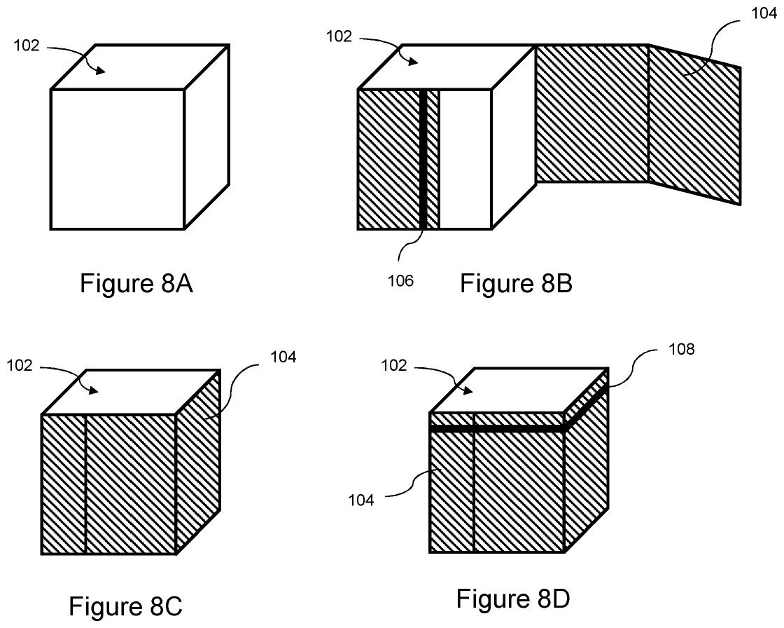

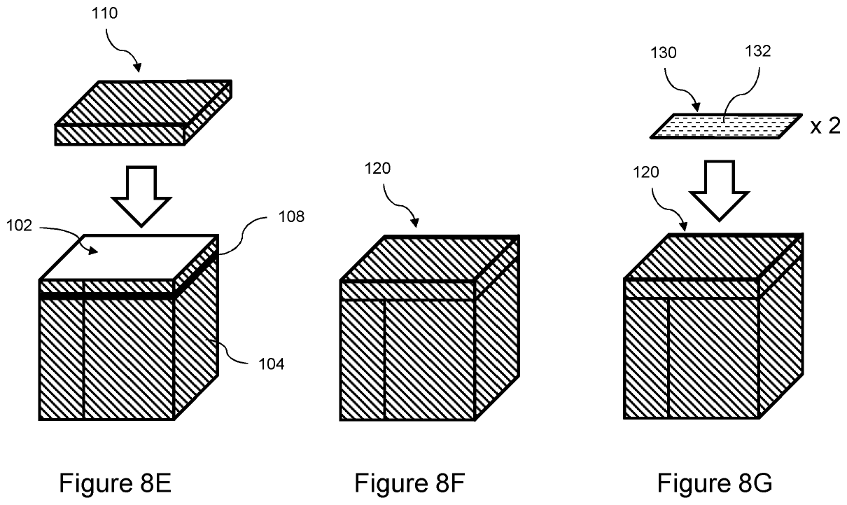

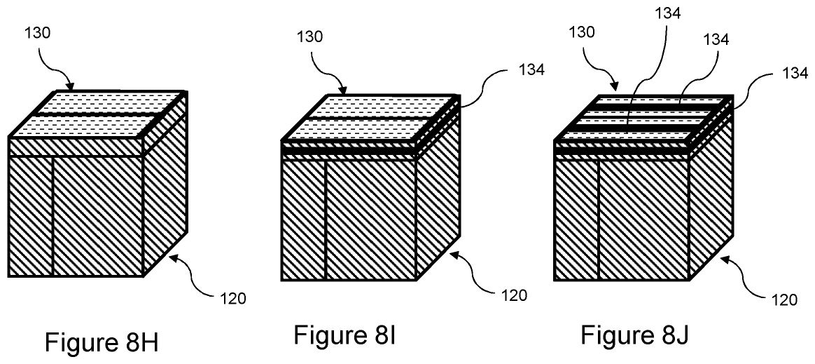

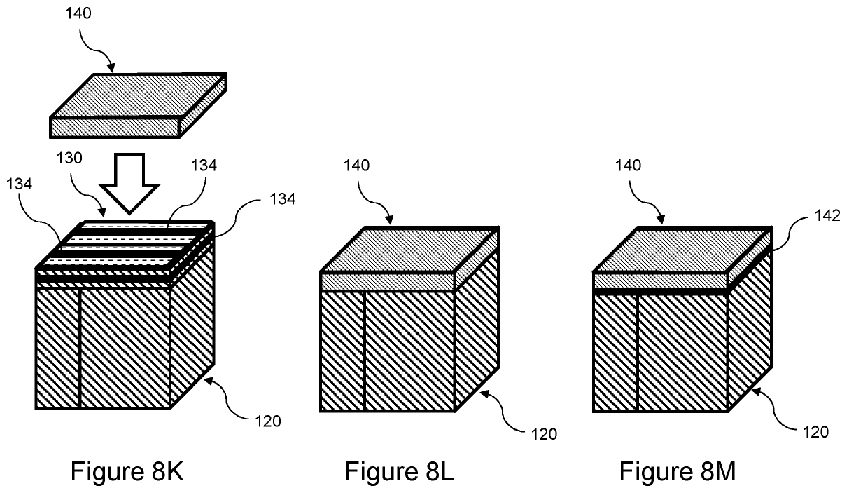

Referring now to FIGS. 8A to 8M, a method of assembling a cargo cover having four sides, a top comprising a PCM, and a bottom opening for receiving cargo 100 uses a former 102. As shown in FIG. 8A, the former 102 is cube shaped. However, it may be alternatively be rectangular prism or any other suitable shape. The former 102 may be made of any suitable material, for example such as wood, metal or plastic.

Referring to FIGS. 8B and 8C, a sheet of material—in this embodiment a cargo cover laminate, such as any of the vapour permeable or impermeable cargo cover laminates described herein—is wrapped around the former 102 to form a wall 104, which is sealed to itself using double sided tape 106 to provide a cube shaped body with four closed sides and two open sides on opposing faces.

Double sided tape 108 is wound around the top of the wall 104 as shown in FIG. 8D, and a first top cover 110 placed over the top of the wall 104 to obscure one of the open sides, and attached in place with the double sided tape 108. The former 102 is then removed to leave behind a cube shaped cargo cover 120, having five closed faces (four sides, and a top face) and an open face comprising a bottom opening for receiving cargo as shown in FIG. 8F.

Alternatively, adhesives may be used instead of double sided tape 108, and may be applied to the first top cover 110 and/or the wall 104.

In some embodiments, the former 102 may be removed once the wall 104 is formed in FIG. 8C, or once the double sided tape has been 108 has been wound around the top of the wall 104 in FIG. 8D, prior to the first top cover 110 being placed over the top of the wall 104 and attached in place with the double sided tape 108.

The first top cover 110 is assembled to form a rectangular sheet of material—in this embodiment a cargo cover laminate such as any of the vapour permeable or impermeable cargo cover laminates described herein—approximately 100 mm longer and wider than the top of the former 102. At each corner of the rectangular sheet, 50 mm cuts are made into the sheet, to allow corners to be formed to a depth of 50 mm. This creates a 50 mm upstand around the perimeter of first top cover 110, which can wrap around and attach to the double sided tape 108 at the top of wall 104. This allows the first top cover 110 to be attached to the top of wall 104 to form cube shaped cargo cover 120.

Referring to FIG. 8G, two pouches 130 filled with PCM 132 are placed side by side on an outer surface of the first top cover 110 (i.e. over the top of cube shaped cargo cover 120) as shown in FIG. 8H. Each pouch is in the form of a strip, which may be continuous or comprise discrete packages of PCM. The two PCM pouches 130 are arranged in parallel, so that together they completely obscure the upper face of the cargo cover 120 (i.e. the upper surface of the first top cover 110). The pouches 130 are arranged such that gaps therebetween are minimised to reduce the risk of thermal bypass of the PCM 132. The pouches 130 may in some embodiments extend beyond the upper face of the cargo cover 120 and bend so that they also extend partially over one or more of the sides of the wall 104. Additional adhesive may be used to further secure the two pouches 130 to the top of cube shaped cargo cover 120 and/or to the sides of the wall 104. The PCM 132 may be in the form of a gel or liquid, for example, but in this embodiment is held within the pores of a flexible porous medium such as a melt-blown polypropylene fibre wadding.

Double sided tape 134 is then wound around the top of the walls of cube shaped cargo cover 120 as shown in FIG. 8I, and optionally also over the pouches 130 as shown in FIG. 8J. A second top cover 140 is placed over the top of the pouches 130 and attached in place with the double sided tape 134 as shown in FIGS. 8K and 8L. Alternatively, adhesives may be used instead of double sided tape 134. The second top cover 140 may constructed in the same way as the first top cover 110, as described above. The second top cover protects the PCM pouches 130 and provides an aesthetically pleasing finish.

Finally, a finishing tape 142, which can be made of cargo cover laminate with a layer of adhesive on one side, is adhered to the join between the second top cover 140 and the cube shaped cargo cover 120, to form the cargo cover having four sides, a top comprising a PCM and a bottom opening for receiving cargo 100. The finishing tape 142 provides an airtight and more aesthetically pleasing finish.

1. A flexible, vapour permeable cargo cover laminate comprising:
an outer layer comprising a substrate bearing a coating, the coating having particles of infra-red reflective matter dispersed within a polymeric matrix and providing an exposed low-emissivity surface on an outward face of the outer layer; and
a support layer laminated to an inward face of the outer layer.

2. The vapour permeable laminate of claim 1 having a moisture vapour transmission rate (MVTR) of at least 100 g/m².day and wherein the low-emissivity surface has an emissivity of less than 0.5.

3. The vapour permeable laminate of claim 1 or claim 2, wherein the substrate comprises a microporous membrane of polypropylene.

4. The vapour permeable laminate of any preceding claim, wherein the polymeric matrix of the coating layer comprises polymer chains having relatively high and relatively lower crystallinity sections to facilitate transfer of moisture vapour by molecular diffusion.

5. The vapour permeable laminate of any preceding claim, wherein the coating comprises a block copolymer selected from styrene butadiene resins and hydrophilic polyurethanes including polyester urethanes, polyether urethanes, polycarbonate urethanes and polyurethane urea polymers, or combinations thereof.

6. The vapour permeable laminate of any preceding claim, wherein the coating comprises a hydrophilic polyurethane.

7. The vapour permeable laminate of any preceding claim wherein the reflective matter is a dispersion of a metal pigment or a pigment which presents a reflective metallic surface.

8. The vapour permeable laminate of any preceding claim wherein the coating has a pigment to binder ratio in the range from 3:1 to 1:10 and/or a coating layer weight per unit area in the range of from 0.8 g/m² to 2.5 g/m².

9. The vapour permeable laminate of any preceding claim wherein the support layer comprises a non-woven fabric.

10. The vapour permeable laminate of any preceding claim wherein the support layer has a white surface with a light reflectivity in the visible range (400-700 nm) of at least 70%, preferably at least 80% or even at least 90%.

11. The vapour permeable laminate of any preceding claim wherein the support layer comprises a metalised or other low-emissivity coating on an inner surface, i.e. a surface facing towards cargo covered by the laminate in use.

12. The vapour permeable laminate of any preceding claim comprising an insulation core comprising a fibrous wadding, the insulation core being sandwiched between the support layer and an inner convection barrier layer of the laminate.

13. The vapour permeable laminate of claim 12 wherein the insulation core comprises a plurality of fibrous waddings interleaved with one or more internal convection barriers to restrict convection.

14. The vapour permeable laminate of claim 12 or claim 13 wherein the (uncompressed) thickness of the or each fibrous wadding is 15 mm or less, preferably 11 mm or less.

15. The vapour permeable laminate of any one of claims 12 to 14, wherein the inner convection barrier layer comprises a non-woven spunbond having a metallised low-emissivity surface facing the insulation core.

16. The vapour permeable laminate of any one of claims 12 to 15 wherein the inner convection barrier layer and any internal convection barriers are adhesively attached to neighbouring fibrous waddings by spots of adhesive.

17. The vapour permeable laminate of any preceding claim comprising a phase change material encapsulated within a liquid impermeable material.

18. The vapour permeable laminate of any preceding claim comprising an overlap or overhang and/or an adhesive strip for affixing the laminate to a neighbouring laminate.

19. A flexible vapour impermeable cargo cover laminate comprising:
a vapour impermeable outer layer comprising an exposed low-emissivity surface on an outward face of the outer layer;
an inner convection barrier layer; and
an insulation core comprising a fibrous wadding, the insulation core being sandwiched between the outer and inner layers.

20. The vapour impermeable laminate of claim 19 wherein the outer layer comprises a metallic or metallised film.

21. The vapour impermeable laminate of claim 19 or claim 20 wherein the insulation core and/or inner convection barrier layer are as defined in any of claims 13 to 16.

22. The vapour impermeable laminate of any one of claims 19 to 21 comprising a phase change material encapsulated within a liquid impermeable material.

23. The vapour impermeable laminate of any one of claims 19 to 22 comprising an overlap or overhang and/or an adhesive strip for affixing the laminate to a neighbouring laminate.

24. A cargo cover comprising a plurality of flexible insulation laminates, each laminate being joined to, or arranged to be joined to, at least one other of the laminates, wherein one or more of the laminates is a laminate according to any preceding claim.

25. A cargo cover comprising:
a first flexible insulation laminate for covering a first part of the cargo, the first laminate comprising a first arrangement of layers; and
a second flexible insulation laminate for covering a second part of the cargo, the second laminate comprising a second arrangement of layers which is different from the first arrangement of layers,
the first laminate being joined to, or arranged to be joined to, the second laminate.

26. The cargo cover of claim 25 comprising one or more further flexible insulation laminates for covering one or more further parts of the cargo, said one or more further laminates comprising further arrangements of layers different from the first and second arrangements of layers and being joined to, or arranged to be joined to, at least one of the first and second laminates.

27. The cargo cover of claim 25 or claim 26 comprising a plurality of first laminates and/or a plurality of second laminates.

28. The cargo cover of any one of claims 25 to 27 wherein the first and/or second laminate comprises a cargo cover laminate according to any one of claims 1 to 22.

29. The cargo cover of any one of claims 25 to 28 wherein the first flexible insulation laminate is arranged to cover a top of the cargo and the second flexible insulation laminate is arranged to cover a side of the cargo.

30. The cargo cover of any one of claims 25 to 29 wherein the first flexible insulation laminate is arranged to cover a top of the cargo and comprises a vapour permeable laminate according to any one of claims 1 to 18.

31. The cargo cover of any one of claims 25 to 30 wherein the second flexible insulation laminate is arranged to cover a side of the cargo and comprises a vapour permeable laminate according to any one of claims 1 to 18 or a vapour impermeable laminate according to any one of claims 19 to 23.

32. The cargo cover of any one of claims 25 to 31 wherein the first flexible insulation laminate has a higher thermal resistance than the second flexible insulation laminate.

33. The cargo cover of any one of claims 24 to 32 having a box-shaped configuration defining a cavity for receiving a pallet of cargo.

34. The cargo cover of any one of claims 24 to 33 wherein the cargo cover laminates comprise fixing means for being fixed together.

35. The cargo cover of any one of claims 24 to 34 wherein at least one of the cargo cover laminates comprises an overlap or overhang and/or an adhesive strip for affixing the laminate to a neighbouring laminate.

36. The cargo cover of any one of claims 24 to 35 wherein at least some of the cargo cover laminates of the cargo cover are joined together before deployment on cargo.

37. The cargo cover of any one of claims 24 to 36 wherein two ends of a cargo cover laminate are joined together to form a side wrap of the cargo cover.

38. The cargo cover of any one of claims 24 to 37 comprising an insulation base comprising a cargo cover laminate according to any one of claims 1 to 21.

39. The cargo cover of claim 38 wherein the insulation base comprises an overhang and/or an adhesive strip for affixing the base to a neighbouring laminate.

40. The cargo cover of any of claims 24 to 39 comprising a phase change material layer.

41. The cargo cover of any of claims 24 to 40, wherein the phase change material layer includes a flexible insulation material comprising a flexible porous medium defining a pore volume, and a phase change material (PCM) within the pore volume.

42. A method of making a cargo cover for covering a cargo, the method comprising the steps of:
forming a first layer arranged to cover at least a portion of the cargo;
arranging a layer of phase change material on the first layer; and
forming a second layer over the layer of phase change material to sandwich the phase change material between the first and second layers.

43. The method of claim 42, including the step of attaching the layer of phase change material to the first layer prior to forming the second layer.

44. The method of claim 42 or claim 43, wherein the step of forming the first layer comprises arranging a sheet of material over a former.

45. The method of any of claims 42 to 44, wherein the step of forming the first layer comprises forming a first portion for covering a first part of the cargo and a second portion for covering a second part of the cargo.

46. The method of any of claims 42 to 45, wherein the step of arranging a layer of phase change material on the first layer includes providing the phase change material on the first and/or second portions of the first layer.

47. The method of any of claims 42 to 46, wherein the first portion of the first layer comprises a top face for covering an upper part of the cargo and the second portion of the first layer comprises one or more side walls for covering one or more sides of the cargo.

48. The method of any of claims 42 to 47, wherein the step of forming the second layer comprises overlaying substantially the whole layer of phase change material, optionally extending beyond a perimeter of the layer of phase change material.

49. The method of any of claims 42 to 48, including the step of attaching the second layer to the first layer to sandwich the phase change material between the first and second layers.

50. The method of any of claims 42 to 49, wherein the first and/or second layers comprise a flexible insulation laminate.

51. The method of any of claims 42 to 50, wherein the first and/or second layers comprise a cargo cover laminate according to any of claims 1 to 24.

52. The method of any of claims 42 to 51, wherein the phase change material layer includes a flexible insulation material comprising a flexible porous medium defining a pore volume, and a phase change material (PCM) within the pore volume.

53. A cargo cover for covering a cargo, the cargo cover comprising a laminate including:
a first layer arranged to cover at least a portion of the cargo;
a layer of phase change material arranged on the first layer; and
a second layer overlaying the layer of phase change material such that the phase change material is sandwiched between the first and second layers.

54. The cargo cover of claim 53, wherein the layer of phase change material is attached to the first layer.

55. The cargo cover of claim 53 or claim 54, wherein the first layer comprises a first portion for covering a first part of the cargo and a second portion for covering a second part of the cargo.

56. The cargo cover of any of claims 53 to 55, wherein the layer of phase change material is provided on the first and/or second portions of the first layer.

57. The cargo cover of any of claims 53 to 56, wherein the first portion of the first layer comprises a top face for covering an upper part of the cargo and the second portion of the first layer comprises one or more side walls for covering one or more sides of the cargo.

58. The cargo cover of any of claims 53 to 57, wherein the second layer substantially overlays the whole layer of phase change material, optionally extending beyond a perimeter of the layer of phase change material, optionally to form an overhang or overlap portion for affixing the second layer to the first layer.

59. The cargo cover of any of claims 53 to 58, wherein the second layer is attached to the first layer to sandwich the phase change material between the first and second layers.

60. The cargo cover of any of claims 53 to 59, wherein the first and/or second layers comprise a flexible insulation laminate.

61. The cargo cover of any of claims 53 to 60, wherein the first and/or second layers comprise a cargo cover laminate according to any of claims 1 to 23.

62. The cargo cover of any of claims 53 to 61, wherein the phase change material layer includes a flexible insulation material comprising a flexible porous medium defining a pore volume, and a phase change material (PCM) within the pore volume.

63. A method of insulating cargo, the method comprising covering the cargo with a cargo cover laminate according to any one of claims 1 to 23 or a cargo cover according to any one of claims 24 to 41 or claims 53 to 62.

64. The method of claim 63, wherein the cargo comprises a pallet of cargo and the method comprises placing over the pallet of cargo a cargo cover according to any one of claims 24 to 41 or claims 53 to 62 having a box-shaped configuration defining a cavity for receiving the pallet of cargo.

65. The method of claim 63 or claim 64 wherein the cargo comprises a temperature-sensitive product, optionally pharmaceuticals and/or perishable food.
